(19) United States
(12) Patent Application Publication
(10) Pub. No.: US 2025/0162080 A1
(43) Pub. Date: May 22, 2025

(54) METHOD FOR MAKING A PERFORATION LINE IN AN AIRBAG COVER

(71) Applicant: JENOPTIK Automatisierungstechnik GmbH, Jena (DE)

(72) Inventor: André KERN, Jena (DE)

(21) Appl. No.: 18/836,594

(22) PCT Filed: Feb. 7, 2023
(86) PCT No.: PCT/EP2023/052958

§ 371 Date: Aug. 7, 2024

(30) Foreign Application Priority Data
Feb. 9, 2022 (DE) 10 2022 103 016.4

(51) Int. Cl. B23K 26/364; B23K 26/03; G01B 11/06

(52) U.S. Cl. CPC B23K 26/364; B23K 26/032; G01B 11/06

(57) ABSTRACT

A method for making a perforation line in an airbag cover, including guiding the airbag cover along an imaginary line relative to a tool; emitting a processing beam and a first measurement beam which act upon a processing site located on a side of the airbag cover facing toward a source of the processing beam; and emitting a second measurement beam which acts upon a measurement location located on a side of the airbag cover facing away from the processing beam source; determining and evaluating a first path length and a second path length; determining, using the first path length and the second path length, a remaining residual wall thickness; and controlling the processing beam source on the basis of the determined remaining residual wall thickness.

### PRIORITY CLAIM

The present application is a National Phase entry of PCT Application No. PCT/EP2023/052958, filed Feb. 7, 2023, which claims priority from German Patent Application No. 10 2022 103 016.4, filed Feb. 9, 2022, the disclosures of which are hereby incorporated by reference herein in their entirety.

### FIELD OF THE INVENTION

The invention relates to a method for making a perforation line in an airbag cover, wherein a residual wall thickness of the airbag cover is determined and a processing beam source is controlled on the basis of the residual wall thickness.

### BACKGROUND OF THE INVENTION

A method for processing a workpiece, which can in particular be a plate-like material for releasing an airbag (airbag cover), is known from DE 10 2018 002 300 A1. For regional weakening, a weakening laser beam is emitted by a weakening laser, which is guided in a manner covering, parallel to or corresponding to a measurement laser beam, said measurement laser beam having a wavelength that differs from the wavelength of the weakening laser beam. A region to be weakened has a higher transmission for the wavelength of the measurement laser beam than for the wavelength of the weakening laser beam. The weakened regions can be arranged next to each other in a row like teeth. The current power of the measurement laser beam is measured by a detection sensor and a residual wall thickness is determined indirectly from the current power using a predefined measurement laser/weakening laser/relative path ratio. The laser power and/or the laser duration of the weakening laser are set based on the residual wall thickness determined. In the disclosed method, transmission of laser radiation through the workpiece is always required to determine the residual wall thickness and consequently to set the parameters of the weakening laser. As a result, only very small residual wall thicknesses can be determined and the process is only suitable for certain workpiece materials with corresponding optical properties.

A further method for laser material processing of a workpiece is disclosed in WO 2014/138939 A1. The method comprises emitting a material processing beam and one or more imaging beams. A phase change region of a workpiece is acted upon by the material processing beam and the at least one imaging beam. The imaging beams are used to perform measurements using low-coherence interferometry at at least one point in the phase change region. For this purpose, the components of the imaging beams reflected by the workpiece are combined with other components, for example from a reference arm, in order to generate an interferometry output based on a path length difference. The interferometry output is then processed to determine at least one characteristic, such as the depth of a blind hole, of the phase change region. Based on the at least one determined characteristic of the phase change region, at least one parameter of the machining process can be controlled.

DE 10 2018 129 407 A1 discloses a method for cutting a workpiece using a laser beam. In said method, a kerf is created on the workpiece with the laser beam emitted by a laser device. Simultaneously, the kerf is acted upon by a measurement beam emitted by a light source of a coherence tomograph. The coherence tomograph has a reference arm from which coupled light is made to interfere with the reflected measurement beam. The measurement beam is deflected to measure the kerf and an interference response is detected to determine at least one geometric property of the kerf. Based on the at least one detected property of the kerf, a process parameter of the cutting process, in particular the parameters of the laser device, can be controlled.

The disadvantage of the two aforementioned methods is that the reference arm is independent of the workpiece in each case. For example, unevenness of a placement surface on which the workpiece rests, unevenness of a surface of the workpiece or a variation in the thickness of the workpiece are not taken into account and lead to an incorrect determination of the remaining wall thickness.

WO 01/70445 A1 discloses a device for making a predetermined breaking line in an airbag cover, which comprises two sensors that are directed towards the processing site from opposite sides. The remaining residual wall thickness is derived from a combination of the signals from both sensors.

EP 1 977 850 B1 discloses a processing device for processing workpieces with a high-energy processing beam. At least one scanning device designed as an optical coherence tomograph is assigned to the processing head, allowing the workpiece surface to be scanned in one, two or three dimensions. Scanning is carried out with the aid of a measurement beam that is emitted by the coherence tomograph and reflected on the workpiece surface. The reflected measurement beam is directed onto a detector at least partially together with a reference light beam.

DE 103 55 931 A1 describes a method for laser drilling and a device for carrying out a method for laser drilling in a plate-shaped component. Before the drilling process, at least one measuring device is used in the drilling region to determine a component thickness of the component, which is defined by the distance between the two component surfaces. A second measuring device is used to record the drilling depth of the borehole during the drilling process.

### SUMMARY OF THE INVENTION

It is the object of the invention to find a method for making a perforation line in an airbag cover, wherein a remaining residual wall thickness can be determined without error, regardless of unevenness or thickness variations, and with which an error-free determination of the remaining residual wall thickness is possible for a workpiece that is opaque in the area of a measurement beam.

According to the invention, a method for making a perforation line in an airbag cover, wherein the airbag cover is guided relative to a tool with a processing beam source and a first measurement beam source along an imaginary line, a processing beam is emitted by the processing beam source, a first measurement beam is emitted by the first measurement beam source and a second measurement beam is emitted by a second measurement beam source, a processing site located on a side of the airbag cover facing the processing beam source is acted upon by the processing beam and the first measurement beam along an illumination axis, wherein the application of the processing beam causes material to be removed at the processing site, a second measurement beam is applied to a measurement location, a first path length of the first measurement beam and a second path length of the second measurement beam are determined, the first path length and the second path length are evaluated, wherein the first path length and the second path length are used to determine a remaining residual wall thickness and the processing beam source is controlled on the basis of the determined remaining residual wall thickness, achieves the object in that, as the measurement location, a location on a side of the airbag cover facing away from the processing beam source, which is located on the illumination axis, is acted upon by the second measurement beam. Before the airbag cover is provided, the distance between the first measurement beam source and the second measurement beam source is determined. The remaining residual wall thickness is then determined from the difference in distance between the first measurement beam source and the second measurement beam source and the sum of the first path length and the second path length. The distance between the first measurement beam source and the second measurement beam source is determined by a reflective element with a defined thickness, the reflective element being provided at the processing site.

Advantageously, the first measurement beam source and/or the second measurement beam source are respectively the measurement beam source of a coherence tomograph and the first path length and/or the second path length is determined by means of optical coherence tomography. To perform optical coherence tomography, the first measurement beam and/or the second measurement beam can be partially reflected or partially transmitted into a reference arm before being acted upon by a beam splitter in the respective beam path. The part of the respective measurement beam that passes through the reference arm is then superimposed with the part of the respective measurement beam reflected by the airbag cover or caused to interfere and an interference response is detected by a detector. The first path length and/or the second path length can be determined from the interference response.

The airbag cover can rest on a placement surface during the entire procedure. The placement surface can be transparent or partially transparent for the second measurement beam so that the second measurement beam can be transmitted through the placement surface before it is applied to the measurement location. Alternatively, the placement surface can have recesses so that the second measurement beam can be transmitted through a recess in the placement surface before it is applied to the measurement location.

The first measurement beam can be favorably guided, before and after acting upon the measurement location, at least in sections, parallel to or overlapping with the processing beam.

It is advantageous if the processing beam has a first wavelength and the first measurement beam has a second wavelength. The first wavelength can differ from the second wavelength. Alternatively, the first measurement beam can be white light radiation.

A laser beam from a fiber laser is particularly suitable as the first measurement beam.

The processing beam is advantageously the laser beam of a CO2 laser. The processing beam source is also advantageously another pulsed laser whose pulse energy, pulse length, repetition frequency and/or emission spectrum are controlled on the basis of the determined residual wall thickness.

### BRIEF DESCRIPTION OF THE DRAWINGS

The invention will be explained in more detail below by way of exemplary embodiments and with reference to drawings, wherein:

FIG. 1 shows a lateral view of an arrangement for carrying out the method, comprising a tool, an airbag cover, a placement surface and a second measurement beam source,

FIG. 2 shows a lateral view of the beam paths of the processing beam, first measurement beam and second measurement beam for determining a residual wall thickness of the airbag cover,

FIG. 3 shows a lateral view of the beam paths of the first measurement beam and the second measurement beam with a reflecting element at the processing site, for determining the distance of the first measurement beam source and the second measurement beam source,

FIG. 4 shows a lateral view of the beam paths of the processing beam, first measurement beam and second measurement beam in an advantageous embodiment of the method, and

FIG. 5 shows a lateral view of the beam paths of the processing beam, first measurement beam and second measurement beam in a further advantageous embodiment of the method.

### DETAILED DESCRIPTION OF THE DRAWINGS

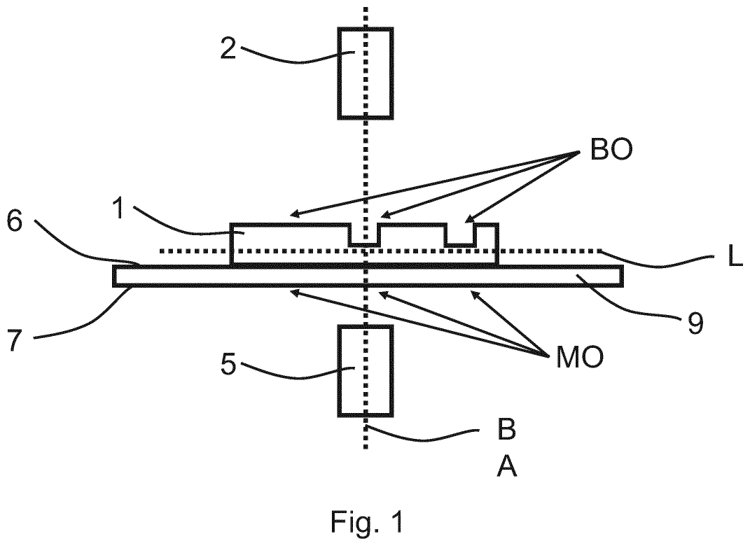

An arrangement for carrying out a method for making a perforation line in an airbag cover 1 is shown schematically in FIG. 1. During the method, the airbag cover 1 is guided along an imaginary line L relative to a tool 2, whereby blind holes can be made at several processing sites BO, which form a perforation line in the airbag cover 1. During the entire processing method, the airbag cover 1 either rests on a placement surface 9 or is held by a robot arm (not shown).

The tool 2 comprises a processing beam source 3 and a first measurement beam source 4. The processing beam source 3 is aligned along an illumination axis BA, which is essentially perpendicular to a side 6 of the airbag cover 1 facing the processing beam source 3. A second measurement beam source 5 is arranged on a side 7 of the airbag cover 1 facing away from the processing beam source 3 during the entire process.

First, the airbag cover 1 is provided, in which a perforation line is to be made. To create the blind holes or the perforation line in the airbag cover 1, the processing beam source 3 emits a processing beam 3.1, which acts upon a processing site BO located on the side 6 of the airbag cover 1 facing the processing beam source 3. Exposure to the processing beam 3.1 causes an energy input at the processing site BO, which results in material removal. At the processing site BO, the airbag cover 1 has a residual wall thickness RWS after exposure to the processing beam 3.1, which is equal to the thickness of the airbag cover 1 at the processing site BO minus the depth of the blind hole. The residual wall thickness RWS is determined at the same time as the airbag cover 1 is processed.

To determine the residual wall thickness RWS, the first measurement beam source 4 emits a first measurement beam 4.1, which acts upon the processing site BO. The first measurement beam 4.1 diffusely reflected from the processing site BO is detected by a detector not shown. By applying the first measurement beam 4.1, a first path length a is thus determined, which corresponds to the distance from the first measurement beam source 4 to the processing site BO. The second measurement beam source 5 emits a second measurement beam 5.1, which is applied to a measurement location MO located on a side 7 of the airbag cover 1 facing away from the processing beam source 3 on the illumination axis BA. The second measurement beam 5.1 reflected from the measurement location MO is detected by a further detector, which is also not shown. By applying the second measurement beam 5.1, a second path length b is determined, which corresponds to the distance from the first measurement beam source 5 to the measurement location MO. The distances are not to be understood as spatial distances, but rather as optical distances or path lengths along the beam paths. Taking into account the first path length a and the second path length b, the remaining residual wall thickness RWS is then to be determined. The processing beam source 3 is controlled depending on the remaining residual wall thickness RWS. In order to determine a residual wall thickness RWS using the first path length a and the second path length b, it is advantageous to know the positions of the first measurement beam source 4 and the second measurement beam source 5 relative to the airbag cover 1 and thus their relative position to each other or at least their distance from each other.

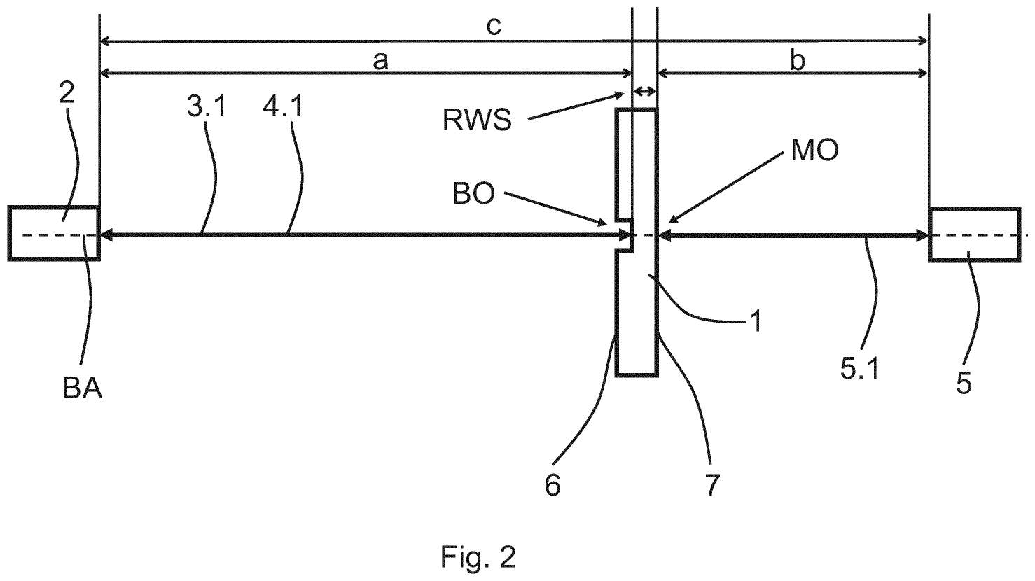

FIG. 2 shows the beam paths of the processing beam 3.1, the first measurement beam 4.1 and the second measurement beam 5.1. In addition, the first path length a, the second path length b and a distance c between the first measurement beam source 4 and the second measurement beam source 5 are identified. As shown in FIG. 2, the processing beam 3.1 and the first measurement beam 4.1 can overlap. However, the first measurement beam 4.1 can also not run along the illumination axis BA. The first measurement beam 4.1 can, in particular, run parallel or at least partially parallel to the axis of illumination BA.

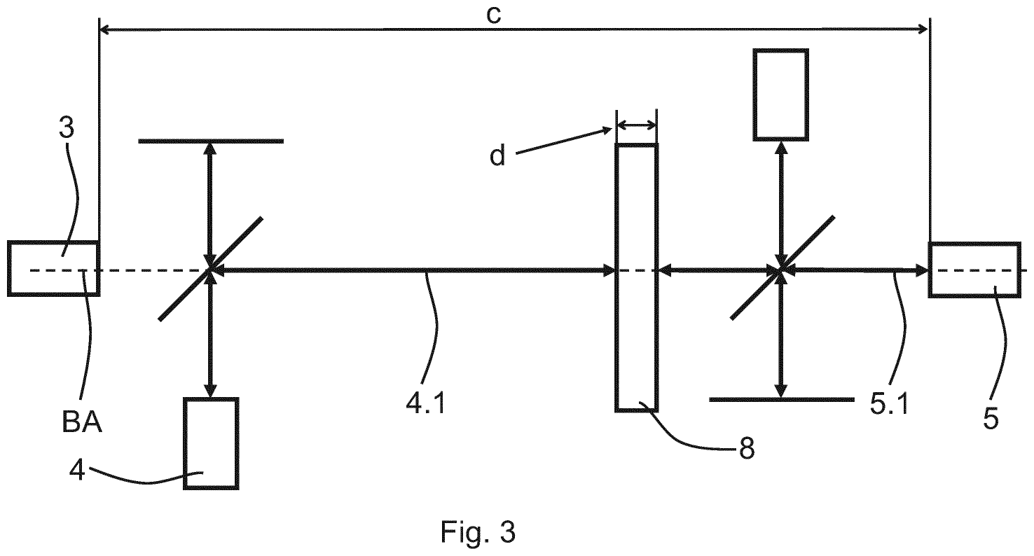

Before the airbag cover 1 is provided, the distance c between the first measurement beam source 4 and the second measurement beam source 5 can be determined in order to determine the remaining residual wall thickness RWS from the difference between the distance c and the sum of the first path length a and the second path length b. FIG. 3 shows an arrangement for determining the distance c. The distance c is determined by inserting a reflective element 8, which has a defined thickness d. If the thickness d of the reflective element 8 along the illumination axis BA is known, the distance c can be determined by determining the first path length a and the second path length b, which results from the sum of the first path length a, the second path length b and the thickness d of the reflective element 8. Here too, the first path length a and the second path length b can be determined using optical coherence tomography. The distance c between the first measurement beam source 4 and the second measurement beam source 5 can also be determined by determining the position of the measurement beam sources or by applying a reflective coating to one of the measurement beam sources. FIG. 3 shows the detector for the second measurement beam source 5, which is arranged opposite a reference arm behind a beam splitter.

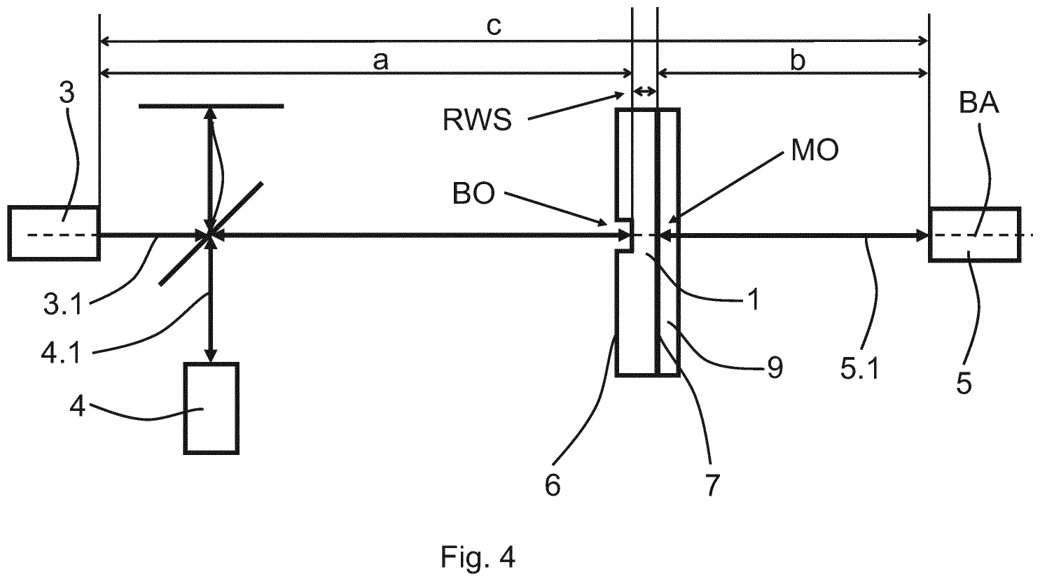

The first path length a and/or the second path length b can be determined using optical coherence tomography. For this purpose, a beam splitter is provided in the respective measurement beam path, which partially reflects or partially transmits the light coming from the measurement beam source into a reference arm. A mirror is arranged in the reference arm, which reflects the part of the measurement beam reflected into the reference arm back to the beam splitter. At the measurement location MO and/or at the processing site BO, part of the incident measurement beam is also reflected and combined again at the beam splitter with the part of the measurement beam reflected into the reference arm. The two parts of the measurement beam interfere with each other and a path length difference between the part of the measurement beam reflected into the reference arm and the transmitted part of the measurement beam can be determined from an interference response detected by a detector. The first path length a and/or the second path length b can then be determined from this path length difference. FIG. 4 shows such a reference arm including beam splitter and plane mirror for the first measurement beam source 4.

If the airbag cover 1 rests on a placement surface 9 during the entire process, it always does so with the side 7 facing away from the processing beam 3.1. As also shown in FIG. 4, the first measurement beam 4.1 can also be guided only partially overlapping with the processing beam 3.1. In order for a residual wall thickness RWS to be determined, the second measurement beam 5.1 emitted by the second measurement beam source 5 must be able to pass through the contact surface 9 to the measurement location MO. For this purpose, the placement surface 9 can be at least partially transparent for the second measurement beam 5.1. This has the advantage that any processing site BO and therefore any measurement location MO can be selected.

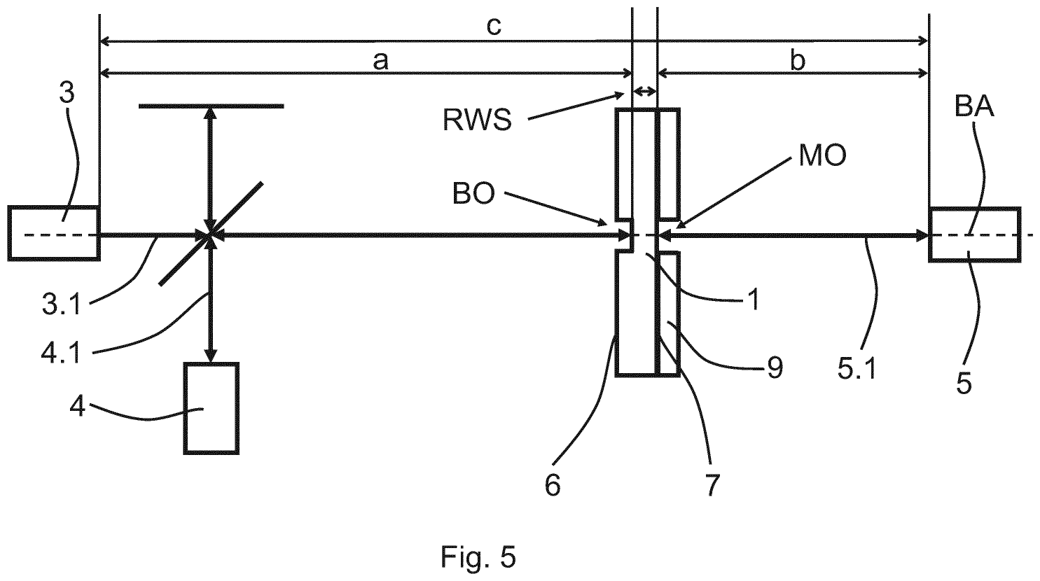

Alternatively, the placement surface can have a recess through which the second measurement beam 5.1 reaches the airbag cover 1, as shown in FIG. 5.

### LIST OF REFERENCE NUMERALS

1 airbag cover
2 tool
3 processing beam source
3.1 processing beam
4 first measurement beam source
4.1 first measurement beam
5 second measurement beam source
5.1 second measurement beam
6 side facing the processing beam source
7 side facing away from the processing beam source
8 reflective element
9 placement surface
a first path length
b second path length
c distance
d thickness
BA illumination axis
BO processing site
MO measurement location
RWS residual wall thickness
L imaginary line

1. A method for making a perforation line in an airbag cover, wherein the airbag cover is guided relative to a tool with a processing beam source and a first measurement beam source along an imaginary line, said method comprising the steps of:
providing an airbag cover,
emitting a processing beam with the processing beam source;
emitting a first measurement beam with the first measurement beam source;
emitting a second measurement beam with a second measurement beam source;
applying the processing beam and the first measurement beam along an illumination axis to a processing site located on a side of the airbag cover facing the processing beam source, wherein the application of the processing beam causes material to be removed at the processing site;
applying a second measurement beam to a measurement location;
determining a first path length of the first measurement beam;
determining a second path length of the second measurement beam;
evaluating the first and second path lengths, the first and second path lengths being used to determine a parameter, and
controlling the processing beam source on the basis of the determined parameter,
wherein:
the parameter is a remaining residual wall thickness, and
as a measurement location, a site on a side of the airbag cover facing away from the processing beam source, which is located on the illumination axis, is acted upon by the second measurement beam and, before the airbag cover is provided, a distance between the first measurement beam source and the second measurement beam source is determined and the remaining residual wall thickness is determined from a difference between the distance and the sum of the first path length and the second path length, and
the distance of the first measurement beam source and the second measurement beam source is determined, before providing the airbag cover, by a reflective element with a defined thickness, the reflective element being provided at the processing site.

2. The method for making a perforation line in an airbag cover according to claim 1, wherein the first measurement beam source is the measurement beam source of a coherence tomograph and the first path length is determined using optical coherence tomography.

3. The method for making a perforation line in an airbag cover according to claim 1, wherein the second measurement beam source is the measurement beam source of a coherence tomograph and the second path length (b) is determined using optical coherence tomography.

4. The method for making a perforation line in an airbag cover according to claim 1, wherein the airbag cover rests on a placement surface during the entire process.

5. The method for making a perforation line in an airbag cover according to claim 4, wherein the second measurement beam is transmitted through the placement surface before acting upon the measurement location.

6. The method for making a perforation line in an airbag cover according to claim 4, wherein the second measurement beam is transmitted through a recess in the placement surface before acting upon the measurement location.

7. The method for making a perforation line in an airbag cover according to claim 1, wherein the first measurement beam is guided, at least in some sections, in a manner parallel to or covering the processing beam.

8. The method for making a perforation line in an airbag cover according to claim 1, wherein the processing beam has a first wavelength, the first measurement beam has a second wavelength, and the first wavelength differs from the second wavelength.

9. The method for making a perforation line in an airbag cover according to claim , wherein the first measurement beam is white light radiation.

10. The method for making a perforation line in an airbag cover according to claim 1, wherein the first measurement beam is the laser beam of a faser laser.

11. The method for making a perforation line in an airbag cover according to claim 1, wherein the processing beam is the laser beam of a CO₂ laser.
